(19) United States
(12) Patent Application Publication
(10) Pub. No.: US 2012/0265563 A1
(43) Pub. Date: Oct. 18, 2012

(54) SYSTEM AND METHOD FOR AUTOMOBILE COLLISION REPAIR

(76) Inventor: David J. Kwasny, Oconomowoc, WI (US)

(21) Appl. No.: 13/270,066

(22) Filed: Oct. 10, 2011

Related U.S. Application Data
(60) Provisional application No. 61/391,603, filed on Oct. 9, 2010.

(51) Int. Cl. G06Q 50/10; G06Q 10/02

(52) U.S. Cl. 705/5; 705/305

(57) ABSTRACT

The claimed invention relates to new and improved means for coordinating automobile collision and mechanical repair services. The claimed invention is also adaptable for use with restoration and aftermarket installation services. More specifically, the claimed invention relates to use of a secure website to offer an exclusive, comprehensive and convenient concierge style auto repair solution for modern lifestyle type customers.

### PRIORITY

This application claims the benefit and priority of U.S. Provisional Patent Application No. 61/391,603 filed Oct. 9, 2011.

### FIELD OF THE INVENTION

The claimed invention relates to new and improved means for coordinating automobile collision repair services. More specifically, the claimed invention relates to use of a secure website to offer an exclusive, comprehensive and convenient concierge style auto repair, aftermarket installation and restoration services for modern lifestyle type customers.

### BACKGROUND OF THE INVENTION

In addition to potential injuries, a typical motor vehicle accident victim faces a number of challenges in obtaining competent repair services for his or her automobile. Some of these challenges may include the inconvenience of driving a damaged vehicle to multiple repair facilities to obtain quotes, renting a replacement vehicle, navigating the reimbursement process with insurance companies and even litigation.

A motor vehicle repair facility could assist consumers in navigating at least the repair process by offering more of a full service, concierge style experience to consumers. In addition to benefitting consumers, it is anticipated that the repair facilities following the claimed method will also benefit from increased referral work from happier customers and greater profitability.

It is further envisioned that the claimed method can be tailored to use in connection with installers of aftermarket parts as well as for professionals in the restoration business. It is further envisioned that the claimed method can be tailored for use with vehicle mechanical repair services.

### DETAILED DESCRIPTION OF THE INVENTION

The claimed invention provides a method for providing full service concierge style vehicle mechanical repair, collision repair, aftermarket installation services and restoration services.

The claimed method provides a concierge-type web site for customers in need of automobile repair services, aftermarket installation services or restoration services. More specifically, those consumers in need of such services, for example automobile collision damage repair services, are referred to and can log onto a web site to schedule the repair services and to receive updates regarding the repair services. The web site can be configured to be accessible via personal data device or is accessible via the internet. Once at the site, the customer is provided an online form designed to collect a person's name, address, phone number, internet email address and vehicle information. The site further provides an option for a user to attach digital images of a crash damaged vehicle and then to submit the vehicle information as well as any pictures to the website for a preliminary estimate of repair costs.

Upon submission of the consumer-supplied information, the information is distributed to participating collision repair facilities. Upon receipt of the estimate request, the participating collision repair facilities can process the estimate and reply to the customer with the preliminary quote and with an invitation to repair. Alternatively, the collision repair facility can request additional information or photographs from the customer or potential customer.

If the consumer accepts the preliminary estimate, some additional information may be required of the consumer. For example, the method of the claimed invention could provide options for scheduling repairs, rental or temporary replacement cars, and pickup and drop off services. Additional features could include electronic review and execution of repair related paperwork, vehicle repair lien documents as well as rental agreements for car rentals. The claimed method would also provide several payment options including but not limited to credit card and cash payments.

Once the vehicle repair process has commenced, the website provides an update service for the consumer. The update service can be provided via the electronic media of the consumer's choice, whether via secure log-in to the website itself; text message, email, Twitter or Facebook. Such a repair process might include everything from acknowledging receipt of an order to delivery of the finished vehicle. Additional intermediate steps may include: an opt in/opt out request so that consumers can determine which updates they want and how they would like to receive their updates; when the car has been retrieved for work, when repair parts are matched to the car; when vehicle structural repair begins or is completed; when vehicle body repair begins or is completed; when vehicle assembly or reassembly begins or is completed; when vehicle paint preparation and vehicle painting begins or is completed; and when the final vehicle has completed the final inspection process. Additionally, the claimed method envisions the use of photographic proof of progress at each individual stage.

The claimed invention can also provide for vehicle delivery scheduling including scheduling the return of a replacement vehicle and scheduling a pickup time for the vehicle. The claimed invention also provides for customer follow-up by one of the selected means for communication, that is, text, email or Facebook. The claimed method may further include the use of surveys to obtain customer feedback.

In accordance with the foregoing, it will be understood that there has been provided a new and nonobvious method and system for coordinating automobile collision repair. Various modifications may be made without departing from the spirit and scope of the invention.

What is claimed is:

1. A method for providing concierge style automobile collision repair services generally comprising the steps of:
establishing a web site;
compiling a database of vehicle repair facilities;
providing a website for entry of consumer information by a consumer comprising personal information, vehicle information and vehicle damage information via the web site;
directing the consumer information provided by the consumer to the vehicle repair facilities;
transmitting preliminary repair estimates generated by the vehicle repair facilities to consumers; and
providing updates on the progress of repairs to consumers.

2. The method for providing concierge style auto repair services of claim 1 further comprising the step of providing a website utility for uploading pictures of a damaged vehicle.

3. The method for providing concierge style auto repair services of claim 1 further comprising the step of providing online scheduling of repairs.

4. The method for providing concierge style auto repair services of claim 1 further comprising the step of providing online reservations for rental or temporary replacement cars.

5. The method for providing concierge style auto repair services of claim 1 further comprising the step of providing online reservations for consumer pickup and drop off services.

6. The method for providing concierge style auto repair services of claim 1 further comprising the step of providing online review and execution of repair related paperwork, vehicle repair lien documents as well as rental agreements for car rentals.

7. The method for providing concierge style auto repair services of claim 1 further comprising the step of providing online payment processing.

8. The method for providing concierge style auto repair services of claim 1 further comprising the step of providing update services via the customer's electronic media of choice.

9. The method for providing concierge style auto repair services of claim 8 wherein the electronic media available for use in communicating updates comprise text message, email, Twitter or Facebook.

10. The method for providing concierge style auto repair services of claim 1 further comprising the steps of:
providing an opt in/opt out request so that consumers can determine which updates they want and how they would like to receive their updates;
providing an update when a consumer's vehicle has been retrieved for work; when repair parts are matched to the car; when vehicle structural repair begins; when vehicle body work repair begins; when vehicle assembly or reassembly is complete; when vehicle paint preparation begins; and when final vehicle inspection occurs.

11. The method for providing concierge style auto repair services of claim 10 further comprising the steps of providing photographic proof of progress at each individual stage.

12. A method for providing concierge style automobile collision repair services generally comprising the steps of:
establishing a web site;
compiling a database of vehicle repair facilities;
providing a website for consumers to enter consumer information comprising personal information, vehicle information and vehicle damage information via the web site;
providing a website utility for uploading pictures of a damaged vehicle. directing the consumer information provided by the consumer to the vehicle repair facilities;
transmitting preliminary repair estimates generated by the vehicle repair facilities to consumers;
providing online scheduling of repairs;
providing online reservations for rental or temporary replacement cars; and
providing electronic updates on the progress of repairs to consumers.

13. The method for providing concierge style auto repair services of claim 12 further comprising the step of providing online review and execution of repair related paperwork, vehicle repair lien documents as well as rental agreements for car rentals.

14. The method for providing concierge style auto repair services of claim 12 further comprising the step of providing online payment processing.

15. The method for providing concierge style auto repair services of claim 12 further comprising the step of providing update services via the customer's electronic media of choice.

16. The method for providing concierge style auto repair services of claim 12 wherein the electronic media available for use in communicating updates comprise text message, email, Twitter or Facebook.

17. The method for providing concierge style auto repair services of claim 1 further comprising the steps of:
providing an opt in/opt out request so that consumers can determine which updates they want and how they would like to receive their updates;
providing an update when a consumer's vehicle has been retrieved for work;
when repair parts are matched to the car; when vehicle structural repair begins; when vehicle body work repair begins; when vehicle assembly or reassembly is complete;
when vehicle paint preparation begins; and when final vehicle inspection occurs.

18. The method for providing concierge style auto repair services of claim 17 further comprising the steps of providing photographic proof of progress at each individual stage.
